(19) United States
(12) Patent Application Publication
(10) Pub. No.: US 2012/0273984 A1
(43) Pub. Date: Nov. 1, 2012

(54) PROCESS FOR RECYCLING MULTIPHASE MOLDINGS

(75) Inventors: Philippe Desbois, Edingen-Neckarhausen (DE); Dietrich Scherzer, Neustadt (DE); Andreas Wollny, Ludwigshafen (DE); Andreas Radtke, Mannheim (DE); Jan Kurt Walter Sandler, Heidelberg (DE)

(73) Assignee: BASF SE, Ludwigshafen (DE)

(21) Appl. No.: 13/454,320

(22) Filed: Apr. 24, 2012

Related U.S. Application Data
(60) Provisional application No. 61/479,862, filed on Apr. 28, 2011.

(51) Int. Cl. B29C 44/06; C08L 77/00; C08J 11/04

(52) U.S. Cl. 264/45.4; 521/48; 521/134

(57) ABSTRACT

The present invention relates to a process for recycling multiphase moldings.

The present invention relates to a process for recycling multiphase moldings. Multiphase moldings (laminates), e.g. made of a solid foam and of unfoamed polyamide produced via anionic polymerization, are used by way of example for sound-deadening and for weight reduction. It would be advantageous if said moldings could be recycled at the end of their life.

Some recycling processes are known in the prior art.

If the polymer foam and the unfoamed polyamide phases are compatible with one another, for example if the polymer in both phases is a polyamide, the laminate can be heated and, for example, compressed by a press or a ram, and then ground, see by way of example Seelig et al., Entwicklung eines Recycling-Verfahrens für Guβ-Polyamide [Development of a recycling process for cast polyamides], final report on a development project sponsored by the Deutsche Bundesstiftung Umwelt [German Federal Environmental Foundation], 1998. The process described grinds the molding.

The polyamide phases can be recycled chemically, see by way of example Braun et al., Chemie, Ingenieur, Technik (73), 2001, pp. 183-190. This method can be useful if the two phases are not composed of the same material, e.g. if the foamed polymer is composed of polypropylene and the unfoamed phase is composed of polyamide, since it can separate the polypropylene phase from the degraded polyamide phase. However, chemical recycling is very complicated.

It was therefore an object to provide a process of maximum simplicity which can recycle multiphase moldings and which can also be applied to cast polyamide. The molding should as far as possible be recyclable without prior separation of the foam component from the unfoamed phase.

Surprisingly, said object was achieved by heating and compressing and grinding the multiphase molding and plastifying and processing the material, optionally with the addition of additives and, if necessary, of further polymers.

The present invention therefore provides a process for recycling multiphase moldings (F1) comprising at least one foamed phase and at least one unfoamed phase produced via reaction injection molding (RIM), where the molding is first compressed, comminuted, and heated, and then is processed in the plastified state to give a molding (F2).

The present invention also provides a molding (F2) which can be produced by the process of the invention.

The molding that can be produced in the invention can be used like any other conventional polyamide pellets.

The moldings (F1) to be recycled are composed of at least one solid foam phase and of at least one unfoamed phase, in particular cast polyamide phase, and both can be filled phases. Typical fillers are fibers (glass, carbon, aramid) which can be long, short, or woven (textile), or laid (laid scrim). Other examples of inorganic fillers are calcium carbonate, mica, aluminum trihydrate, magnesium hydroxide, and talc powder, to mention just a few. It is also possible to use organic fillers, for example wood, rubber, and flame retardants.

The expression “cast polyamides” means polyamides produced via anionic polymerization. Examples of typical monomers here are lactams, such as caprolactam, piperidone, pyrrolidone, laurolactam, and mixtures of these; preference is given to caprolactam, laurolactam, and mixtures of these, and particular preference is given to caprolactam or laurolactam. The polymer chains can be linear, crosslinked, cyclic, or branched chains.

One or more phases has/have been foamed. Typical foams are polymer foams, e.g. made of polyamide, polystyrene, polypropylene, polyurethane, polyamide, or PVC, to mention just a few. It is also possible to use other foams, such as melamine-formaldehyde foam (Basotect® from BASF).

In one embodiment of the invention, the foamed phase comprises at least one compound selected from the group of polyamide, polybutylene terephthalate (PBT), polyethylene terephthalato (PET), polycarbonate (PC), styrene-acrylonitrile (SAN), styrene-acrylonitrile-methacrylate (SANMA), acrylic-butadiene-styrene (ABS), polyphenylene ether (PPE), polysulfone (PSU), polyethylene (PE), polyethylene copolymers, polypropylene (PP), and polymethylmethacrylimide (PMI), and polyurethane (PU).

The moldings can have various shapes, examples being layers made of foam and made of anionically produced polylactam, where the anionically produced polylactam often comprises fillers. The material can also be a molding which encloses an inner foam phase and an outer polyamide phase, or vice versa.

In one embodiment of the invention, the multiphase molding (F1) is composed of one or more foamed polyamide phases having >30% by volume, preferably >50% by volume, particularly preferably >70% by volume, of polyamide, and one or more unfoamed polyamide phases produced via anionic polymerization and having >30% by volume, preferably >50% by volume, particularly preferably >70% by volume, of polyamide.

In one preferred embodiment of the invention, the foamed phase of the molding (F1) consists essentially of polyamide.

In another preferred embodiment of the invention, the unfoamed phase of the molding (F1) consists essentially of polyamide.

In order to permit recycling of the multiphase moldings, the intention was to convert them to a state in which new moldings can be produced therefrom. This includes conversion of the molding to a handlable state, the aim then being to produce a product with the desired properties therefrom, optionally via addition of additives, fillers, virgin polymers, rubber, etc.

In order to achieve the handlable state, it is necessary to reduce the volume, which is often determined primarily by the foam. The product can be compressed here, and this can be achieved via pressure and/or heat. Ideally, the temperature should be brought to at least the glass transition temperature or crystallization temperature of the foam—for an amorphous and, respectively crystalline foam—plus 10° C. (preferably plus 20° C.). This can be achieved prior to, during, or after the compression step, but the first two options here are greatly preferred. Prior to, during, or after this step the product can be comminuted, ideally via grinding. The D(50) numerical value of the particles produced via grinding is preferably <10 mm. Said regrind can be used directly, e.g. via injection molding, extrusion, or compression molding.

The D(50) value here implies that 50% by number of the particles have a diameter <10 mm and 50% by number of the particles have a diameter >10 mm, measured along the longest axis. The counting procedure is based on photographs.

In one embodiment of the invention, the processing to give the molding (F2) takes place via injection molding, extrusion, or compression molding, preferably extrusion.

In one embodiment of the invention, the processing in the plastified state involves addition of at least one further additive; the additive here can be one selected from fibers, e.g. glass fibers and/or carbon fibers, compatibilizers, stabilizers, flame retardants, and dyes and/or pigments.

The regrind is normally introduced into an extruder and optionally mixed with virgin polymers or with fillers, such as glass fibers, carbon fibers, and/or aramid fibers; or with additives, e.g. stabilizers, flame retardants, and dyes and/or pigments, to mention just a few, and is then extruded.

The expression “virgin polymers” most frequently means polyamides, rubbers, and polyamide block copolymers, in particular polyamide, but it is also possible to use other polymers.

In the event that the other “virgin polymers” are incompatible or only partially compatible with the recycled product, it can be advantageous to add a compatibilizer. These can be block copolymers, where at least one block is present in one polymer phase and at least one block is present in the other polymer phase of the blend. However, the compatibilizer can also be a polymer which is compatible with the virgin polymer and which comprises reactive groups which react with the other phase. The reactive groups are mostly epoxy or anhydride groups which react with the polyamide phase to give graft copolymers.

The compatibilizer can be present in a mixture in the outer layer of the unfoamed phase (in particular polyamide phase), in a mixture in the foamed phase, or in the form of a reactive group in the polymer chains of the foamed phase.

In one preferred embodiment, a compatibilizer is used which, after the plastification procedure, is found mainly at the interface between two or more polymer phases.

Typical examples of mixtures of recycled molding, compatibilizer, and added virgin polymer are shown below:

| | | |
|---|---|---|
| Recycled multiphase | Polymers | Compatibilizer |
| molding | added | |
| Recycled multiphase | Polypropylene | Polypropylene grafted with |
| molding | | anhydride groups or with epoxy |
| | | groups |
| Recycled multiphase | Polystyrene | Polystyrene-maleic anhydride co- |
| molding | | polymer |
| Recycled multiphase | Polystyrene- | Polystyrene-acrylonitrile-maleic |
| molding | acrylonitrile | anhydride copolymer |

If the foam phase and the polylactam phase in the multiphase molding are not compatible with one another, it is advisable to use a compatibilizer in the manner indicated below prior to or during processing.

| | | |
|---|---|---|
| Foam phase | Cast polyamide | Compatibilizer |
| | phase | |
| Polypropylene | Cast polyamide | Polypropylene grafted with anhydride |
| | | groups or with epoxy groups |
| Polystyrene | Cast polyamide | Polystyrene-maleic anhydride |
| Polystyrene- | Cast polyamide | Polystyrene-acrylonitrile-maleic |
| acrylonitrile | | anhydride |

If the intention is to use a rubber in order to render the recycled molding composition impact-resistant, the rubber should be compatible with one or both polymer phases. Typical examples are, inter alia, EPDM rubbers or ethylene-butyl acrylate rubbers, where these comprise maleic acid groups. The maleic acid groups react with the polyamide and give rubber particles in the polyamide phase, with resultant stabilization of the polyamide chains grafted on the rubber. Another example is the use of EPDM rubbers if polypropylene is used.

### EXAMPLES

Some examples are given below to illustrate some aspects of the present invention. These are merely illustrative and are certainly not intended to restrict the scope of the present invention.

1. A caprolactam mixture (200 g of caprolactam+4 g of C20+8 g of C10 mixed at 100° C. and immediately transferred into a mold) was added at 100° C. to a PA 6 foam (density 100 g/l) of thickness 4 mm, positioned in a mold (8 mm cavity), and the mold here had been heated to 150° C. The mold was opened after 3 min. The resultant laminated molding made of three layers made of polycaprolactam, polycaprolactam foam (PA 6 foam), and polycaprolactam is heated to 200° C. in a press, compressed under pressure, cooled, ground and then injection-molded at 260° C. melt temperature and 60° C. mold temperature. The product has good white color and good toughness.

2. Experiment 1 is repeated, but the regrind is processed at 260° C. in an extruder with 0.5% of Irganox 1098 from Ciba Geigy, and then injection-molded. The moldings are white and have high toughness.

3. Experiment 2 is repeated, but during the extrusion step 30 parts of glass fiber in the form of roving are metered into the polymer melt, for every 70 parts of polymer. The moldings are white and have high toughness and stiffness.

4. A caprolactam mixture (200 g of caprolactam+4 g of C20+8 g of C10 mixed at 100° C. and immediately transferred into a mold) was added at 100° C. to a polypropylene (PP) foam (density 100 g/l) of thickness 4 mm, positioned in a mold (8 mm cavity), and the mold here had been heated to 150° C. The mold was opened after 3 min. The resultant laminated molding made of polycaprolactam, polypropylene foam, and polycaprolactam is heated to 200° C. in a press, compressed under pressure, cooled, and ground and blended at 260° C. in an extruder with 0.5% by weight of Irganox 1098 from Ciba Geigy and 2% of a polypropylene which was grafted with 0.7% by weight of maleic acid. Injection moldings made of the product are white and have good toughness and surface.

5. A caprolactam mixture (200 g of caprolactam+4 g of C20+8 g of C10 mixed at 100° C. and immediately transferred into a mold) was added at 100° C. to a PA 12 foam (density 100 g/l) of thickness 4 mm, positioned in a mold (8 mm cavity), and the mold here had been heated to 150° C. The mold was opened after 3 min.

This gave a sandwich structure of thickness 8 mm, composed of two PA outer layers (in each case of thickness 2 mm) with intrinsic viscosity (IV) of 550 (overall density 0.6 g/l), and 1.3% by volume of residual caprolactam.

This structure is heated to 210° C. (above the melting point of PA 12) and compressed. The resultant material of density 1.1 g/l is comminuted.

6. Example 1 was repeated, except that glass fiber woven (280 g/m², 2/2 twill, No. 92125 from Interglass) is used as outer layer. Six plies of layers respectively of thickness 2 mm are used; glass fiber content is 40% by volume (IV 580).

After compression and comminution, the resultant granulated material is charged at a rate of 5 kg/h to an extruder that has been heated to 250° C. and is melted; virgin PA 6 is metered into this material at a rate of 5 kg/h.

This gives PA pellets with short glass fibers.

7. Example 1 was repeated, except that polyurethane (PU) foam with T_{g} of 170° C. is used. The temperature of the mold here was 130° C.

8. Example 1 was repeated, except that MDI foam from Evonik (Rohacell® 71 IG) is used. The temperature of the mold here was 130° C.

9. Example 1 was repeated, except that polybutylene terephthalate (PBT)/polycarbonate (PC) foam was used. The temperature of the mold here was 130° C.

1. A process for recycling multiphase moldings (F1) comprising at least one foamed phase and at least one unfoamed phase produced via reaction injection molding (RIM), where the molding is first compressed, comminuted, and heated, and then is processed in the plastified state to give a molding (F2), where the unfoamed phase comprises polyamide.

2. The process according to claim 1, where the foamed phase comprises at least one compound selected from the group of polyamide, polybutylene terephthalate (PBT), polyethylene terephthalate (PET), polycarbonate (PC), styrene-acrylonitrile (SAN), acrylic-butadiene-styrene (ABS), polyphenylene ether (PPE), polysulfone (PSU), polyethylene (PE), polyethylene copolymers, polypropylene (PP), and polymethylmethacrylimide (PMI).

3. The process according to either of claims 1 and 2, where the foamed phase comprises polyamide.

4. The process according to any of claims 1 to 3, where the unfoamed phase was produced via anionic polymerization of at least one lactam.

5. The process according to any of claims 1 to 4, where the multiphase molding (F1) is composed of one or more foamed polyamide phases having >30% by volume of polyamide and of one or more unfoamed polyamide phases produced via anionic polymerization and having >30% by volume of polyamide.

6. The process according to any of claims 1 to 5, where the foamed phase consists essentially of polyamide.

7. The process according to any of claims 1 to 6, where the unfoamed phase consists essentially of polyamide.

8. The process according to any of claims 1 to 7, where a compatibilizer is used which, after the plastification procedure, is found mainly at the interface between two or more polymer phases.

9. The process according to any of claims 1 to 8, where the compression process takes place via application of pressure and/or of elevated temperature.

10. The process according to any of claims 1 to 9, where the comminution process takes place via grinding.

11. The process according to any of claims 1 to 10, where, during the heating process, a temperature is set which is at least 10° C. above the crystallization temperature of the foamed phase, if the foamed phase is crystalline, or at least 10° C. above the glass transition temperature of the foamed phase, if this is amorphous.

12. The process according to any of claims 1 to 11, where the processing to give the molding (F2) takes place via injection molding, extrusion, or compression molding.

13. The process according to any of claims 1 to 12, where at least one further polymer is added during the processing in the plastified state.

14. The process according to any of claims 1 to 13, where at least one further additive is added during the processing in the plastified state.

15. A molding (F2) which can be produced by the process according to any of claims 1 to 14.
